(19) United States
(12) Patent Application Publication
(10) Pub. No.: US 2015/0034177 A1
(43) Pub. Date: Feb. 5, 2015

(54) FLOAT VALVE

(71) Applicant: DAEYEONG E&B CO., LTD., Gyeonggi-do (KR)

(72) Inventor: Doo-Ha KIM, Gyeonggi-do (KR)

(73) Assignee: DAEYEONG E&B CO., LTD., Gyeonggi-do (KR)

(21) Appl. No.: 14/265,933

(22) Filed: Apr. 30, 2014

(30) Foreign Application Priority Data
Aug. 1, 2013 (KR) 10-2013-0091686

(51) Int. Cl. F16K 31/20; F16K 37/00; F16K 31/26

(52) U.S. Cl. CPC F16K 31/20; F16K 31/265; F16K 37/00
USPC 137/438; 137/409

(57) ABSTRACT

There is provided a float valve. The float valve includes: a frame; a water supply part fixed to the frame and including a water supply nozzle through which water is discharged; a vertical bar fixedly coupled to the frame and extending downwardly below the water supply unit; a float connected to the vertical bar and vertically movable along the vertical bar; a switching unit connected to the float and configured to open or close the water supply nozzle while being moved vertically according to vertical movement of the float; and a water level sensor disposed on the vertical bar to detect a position of the float. Since the water level senor is integrated in the float valve, the inside space of a product using the float valve may be efficiently used, and parts of the product may be simply assembled.

### CROSS-REFERENCE TO RELATED APPLICATION

This application claims the benefit of Korean Patent Application No. 10-2013-0091686 filed on Jan. 8, 2013, with the Korean Intellectual

Property Office, the disclosure of which is incorporated herein by reference.

### BACKGROUND

The present disclosure relates to a float valve, and more particularly, to a float valve in which a water level sensor is integrated.

Float valves are widely used in water purifier tanks and toilet tanks to supply a certain amount of water.

FIG. 1 is a side view illustrating a float valve of the prior art.

Referring to FIG. 1, the float valve of the prior art includes: a water supply part 10 including a water supply nozzle 12 through which water is supplied to a water tank; a float 20 floating on water stored in the water tank; a lever 30 connecting the float 20 to the water supply part 10 in a rotatable manner; and a packing 40 disposed on the lever 30 to close the water supply nozzle 12 when the float 20 is lifted.

In the float valve of the prior art, as shown in the upper region of FIG. 1, if the float 20 is moved down by gravity, the water supply nozzle 12 is opened, and thus water may be supplied to the water tank through the water supply nozzle 12.

As the level of water of the water tank is increased by the supply of water, the float 20 floating on the water is lifted. If a certain amount of water fills the water tank, as shown in the lower region of FIG. 1, the packing 40 disposed on the lever 30 closes the water supply nozzle 12, and then water is not supplied to the water tank.

Some products including water tanks are equipped with water level sensors as well as float valves.

In this case, however, float valves and water level sensors are individually installed. That is, such a product is required to have an installation space for an individually installed float valve as well as a water level sensor.

### SUMMARY

An aspect of the present disclosure may provide a float valve in which a water level senor is integrated.

According to an aspect of the present disclosure, a float valve may include: a frame; a water supply part fixed to the frame and including a water supply nozzle through which water is discharged;

a vertical bar fixedly coupled to the frame and extending downwardly below the water supply unit; a float connected to the vertical bar and vertically movable along the vertical bar; a switching unit connected to the float and configured to open or close the water supply nozzle while being moved vertically according to vertical movement of the float; and a water level sensor disposed on the vertical bar to detect a position of the float.

The water level sensor may include: a reed switch fixed to the vertical bar; and a magnet disposed on the float.

The water level senor may be provided on upper and lower sides of the vertical bar to detect high and low water levels.

The switching unit may include: a connection lever having one end coupled to the float in a vertically rotatable manner; a switching lever having one end coupled to the other end of the connection lever in a vertically rotatable manner and the other end coupled to the frame in a vertically rotatable manner, the switching lever being vertically rotatable under the water supply nozzle; and a packing member disposed on the switching lever to open or close the water supply nozzle according to vertical movement of the switching lever.

The water supply nozzle may be formed through a lower side of the water supply part, and the float may be vertically movable below the water supply nozzle, wherein the switching unit may include: a packing support member disposed on an upper side of the float and adjustable in height; and a packing member disposed on an upper end of the packing support member to open or close the water supply nozzle.

The packing support member may include: a screw rod vertically disposed on the upper side of the float; and a case screw coupled to the screw rod, the packing member being disposed on an upper end of the case.

The vertical bar may have a polygonal pipe or bar shape.

An anti-shaking space may be formed in a lower side of the float.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a side view illustrating a float valve of the prior art;

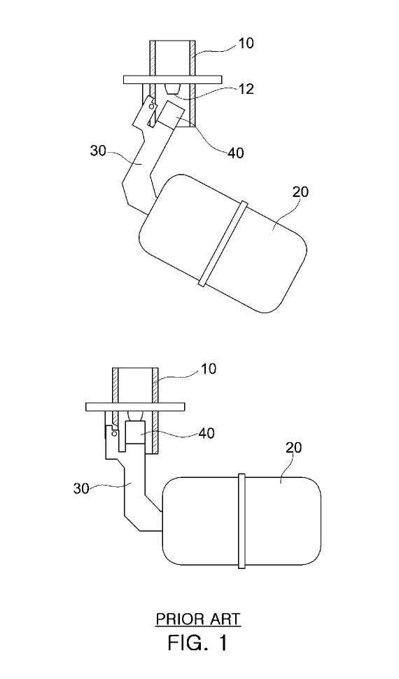

FIG. 2 is a perspective view illustrating a float valve according to an embodiment of the present disclosure;

FIG. 3 is a side cross-sectional view illustrating an opened state of the float valve of FIG. 2;

FIG. 4 is a side cross-sectional view illustrating a closed state of the float valve of FIG. 2;

FIG. 5 is a perspective view illustrating a float valve according to another embodiment of the present disclosure;

FIG. 6 is a side cross-sectional view illustrating an opened state of the float valve of FIG. 5; and

FIG. 7 is a side cross-sectional view illustrating a closed state of the float valve of FIG. 5.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

In the following description, the technical terms are used only for explaining specific exemplary embodiments while not limiting the scope and spirit of the present disclosure. The terms of a singular form may include plural forms unless referred to the contrary.

Hereinafter, exemplary embodiments of the present disclosure will now be described with reference to the accompanying drawings.

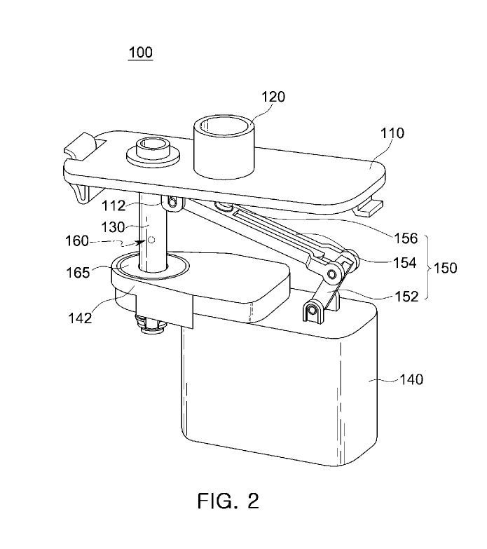

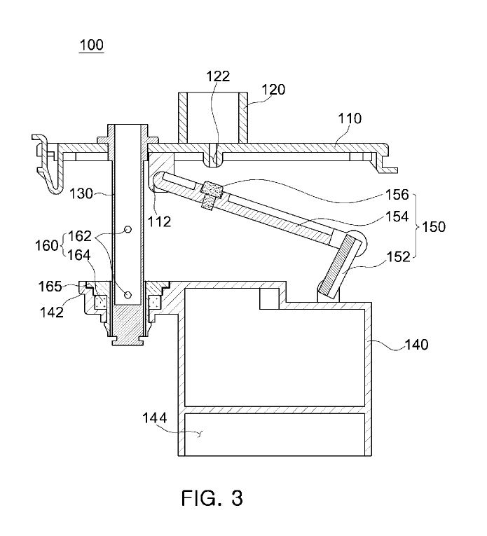

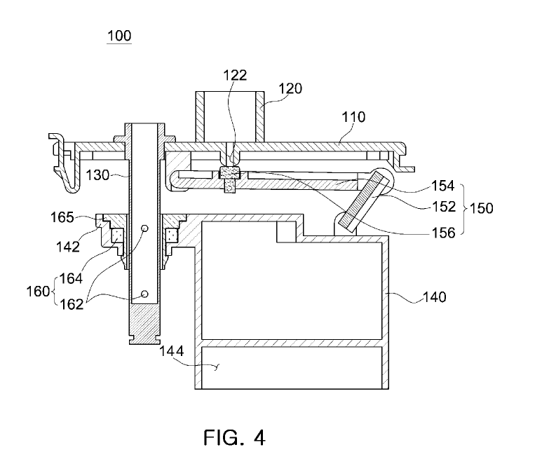

First, with reference to FIGS. 2 to 4, a float valve 100 will be described in detail according to an embodiment of the disclosure. FIG. 2 is a perspective view illustrating the float valve 100 according to an embodiment of the present disclosure. FIG. 3 is a side cross-sectional view illustrating an opened state of the float valve 100, and FIG. 4 is a side cross-sectional view illustrating a closed state of the float valve 100.

Referring to FIGS. 2 to 4, according to the embodiment of the present disclosure, the float valve 100 includes a frame 110, a water supply part 120, a vertical bar 130, a float 140, a switching unit 150, and a water level sensor 160.

The frame 110 is member to which the water supply part 120 and the vertical bar 130 are coupled (to be described later). In the embodiment of the present disclosure, when the float valve 100 is installed on a water tank (not shown), the frame 110 may be a fixing plate attached to the water tank or may be a body of the water tank.

The water supply part 120 is fixed to the frame 110, and an external part such as a pipe or hose may be connected to the water supply part 120 to supply water to the water tank.

The water supply part 120 may be a separate part coupled to the frame 110 or may be formed in one piece with the frame 110.

In addition, the water supply part 120 may include a water supply nozzle 122 through with liquid such as water flows. In the embodiment, the water supply nozzle 122 may be formed through a lower side of the water supply part 120 toward the inside of the water tank as shown in FIGS. 3 and 4.

The vertical bar 130 may be a bar-shaped member fixed to the frame 110 and extending downwardly below the water supply part 120.

In the embodiment, the vertical bar 130 may be provided on the frame 110 at a side of the water supply part 120 and may extend vertically and downwardly from the frame 110. The vertical bar 130 is not limited to a particular structure. For example, the vertical bar 130 may be a pipe or bar having the same thickness in the length direction thereof.

The float 140 is connected to the vertical bar 130 for moving vertically along the vertical bar 130.

To this end, in the embodiment, the float 140 may include a connection part 142, and an insertion nozzle having a size corresponding to the outer diameter of the vertical bar 130 may be formed in the connection part 142. In this structure, the vertical bar 130 may be inserted in the insertion nozzle of the connection part 142 to guide vertical movement of the float 140.

Furthermore, in the embodiment, an anti-shaking space 144 may be formed in a lower side of the float 140. The anti-shaking space 144 maybe a concave space formed in the lower side of the float 140.

In the embodiment, when the float valve 100 is installed on a water tank containing water, the anti-shaking space 144 may separate a region of the water making contact with the lower side of the float 140 and support the float 140 from the other region of the water surrounding the anti-shaking space 144, and thus the float 140 may be less shaken by waves of the water contained in the water tank.

Since the anti-shaking space 144 reduces shaking of the float 140, the water level sensor 160 (to be described later) may precisely detect the level of water.

The switching unit 150 may be connected to the float 140 to open or close the water supply nozzle 122 while move upward and downward together with the float 140.

In the embodiment, the switching unit 150 may include a connection lever 152, a switching lever 154, and a packing member 156.

One end of the connection lever 152 may be coupled to the float 140 in a vertically rotatable manner.

One end of the switching lever 154 may be coupled to the other end of the connection lever 152 in a vertically rotatable manner, and the other end of the switching lever 154 may be coupled to a fixing part 112 formed on a rear side of the frame 110 in a vertically rotatable manner. Owing to the vertically rotatable structure of the switching lever 154, the switching lever 154 may be moved vertically under the water supply nozzle 122.

In the embodiment shown in FIGS. 2 to 4, the connection lever 152 and the switching lever 154 may be connected in the form of a folding ruler. However, the embodiment of the present disclosure is not limited thereto.

The packing member 156 may be disposed on the switching lever 154 to open or close the water supply nozzle 122 according to vertical movement of the switching lever 154. The packing member 156 is not limited to a particular type. That is, the packing member 156 may have any material and shape as long as the packing member 156 can close the water supply nozzle 122 without leakage of liquid.

In the embodiment, the switching unit 150 may be operated as follows. If the float 140 is moved upward, the connection lever 152 is moved upward to lift the switching lever 154, and then the packing member 156 disposed on the switching lever 154 closes the water supply nozzle 122.

The water level sensor 160 may be disposed on the vertical bar 130 to detect the position of the float 140 and thus the level of water filled in the water tank.

In the embodiment, the water level sensor 160 may include reed switches 162 fixed to the vertical bar 130 and magnets 164 disposed on the float 140.

In the embodiment, the magnets 164 may be disposed on the connection part 142 of the float 140 to approach the reed switches 162 disposed on the vertical bar 130. In this case, a fixing part 165 maybe disposed on the connection part 142 to fix the reed switches 162 to the connection part 142.

In this structure, if the magnets 164 are moved upward together with the float 140, the reed switches 162 disposed on the vertical bar 130 are operated by magnetic force of the magnets 164, and thus the level of water filled in the water tank may be detected.

In the embodiment, as shown in FIGS. 3 and 4, the water level sensor 160 may be provided on upper and lower sides of the vertical bar 130 to detect a high water level and a low water level. That is, the reed switches 162 of the water level sensor 160 may be disposed at upper and lower sides (upper and lower positions) of the vertical bar 130 so that the water level sensor 160 can detect a low water level as well as a high water level.

However, the water level sensor 160 is not limited to detecting low and high water levels. That is, the water level sensor 160 may be provided at various positions on the vertical bar 130 to detect various water levels.

As described above, in the embodiment of the present disclosure, the water level sensor 160 is integrated in the float valve 100, and thus the inconvenience of separately installing the float valve 100 and the water level sensor 160 maybe removed. That is, once the float valve 100 is installed, the level of water can be detected using the float valve 100.

In a float valve of the prior art, a float is rotatably supported by a lever. Therefore, if the lever is bent or deformed, a desired amount of liquid may not be filled in a water tank. However, according to the embodiment of the present disclosure, since the float 140 of the float valve 100 is configured to be moved vertically, problems caused by bending or deformation of a lever may not occur, and the water supply nozzle 122 may be reliably closed and opened.

Therefore, in the embodiment of the present disclosure, the water level sensor 160 of the float valve 100 may reliably detect the level of water.

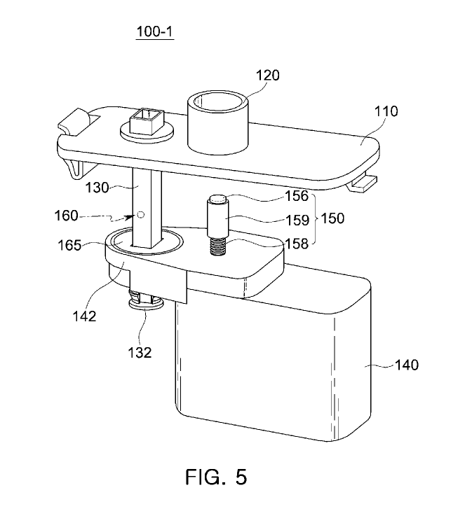

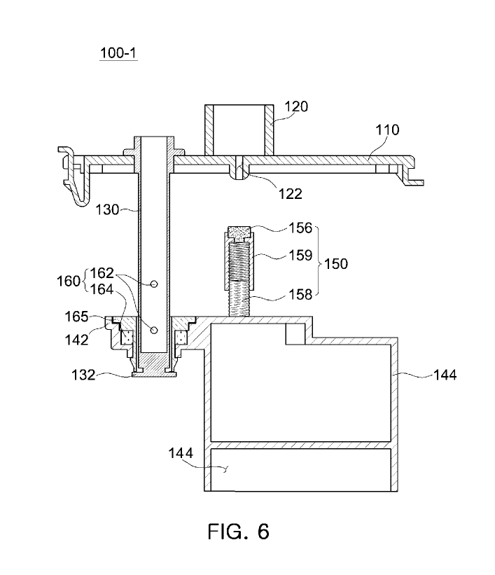

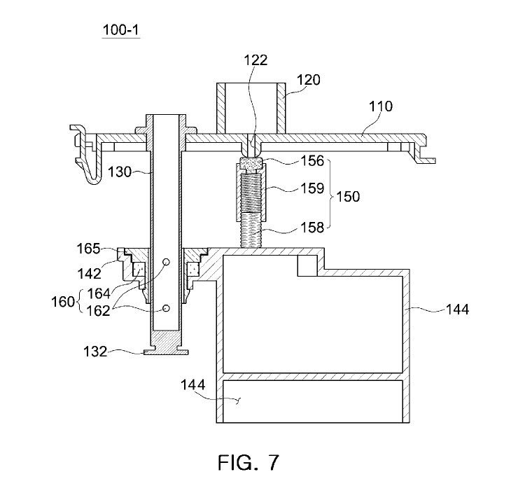

Next, with reference to FIGS. 5 to 7, a float valve 100-1 will be described in detail according to another embodiment of the disclosure. FIG. 5 is a perspective view illustrating the float valve 100-1 according to the other embodiment of the present disclosure. FIG. 6 is a side cross-sectional view illustrating an opened state of the float valve 100-1, and FIG. 7 is a side cross-sectional view illustrating a closed state of the float valve 100-1.

As shown in FIGS. 5 to 7, the configuration of a switching unit 150 of the float valve 100-1 of the current embodiment is different from the configuration of the switching unit 150 of the float valve 100 of the previous embodiment described with reference to FIGS. 2 to 4. Except the switching unit 150, a frame 110, a water supply part 120, a vertical bar 130, a float 140, and a water level sensor 160 of the float valve 100-1 are substantially the same as those of the float valve 100 of the previous embodiment described with reference to FIGS. 2 to 4, and thus descriptions thereof will not repeated.

In the current embodiment, the switching unit 150 may include a packing support member and a packing member 156.

The packing member 156 of the current embodiment is substantially the same as the packing member 156 included in the switching unit 150 of the float valve 100 of the previous embodiment described with reference to FIGS. 2 to 4.

The packing support member is disposed on an upper side of the float 140 and is adjustable in height.

In the current embodiment, the packing support member may include: a screw rod 158 vertically disposed on the upper side of the float 140, and a case 159 screw coupled to the screw rod 158. The packing member 156 is disposed on an upper end of the case 159.

In this structure, the height of the packing support member may be adjusted by adjusting the coupling length of the screw rod 158 and the case 159.

If the vertical bar 130 has a cylindrical shape, the float 140 coupled to the vertical bar 130 may swing forward and backward. To prevent this, in the current embodiment, the vertical bar 130 may have a polygonal pipe or bar shape.

In the current embodiment, one end plate 132 may be provided on a lower end of the vertical bar 130 to limit downward movement of the float 140 and thus prevent the float 140 from separating from the vertical bar 130.

The end plate 132 may be wider than an insertion hole formed in a connection part 142 of the float 140.

In the current embodiment, since the packing support member of the float valve 100-1 is adjustable in height, the amount of liquid to be filled in a water tank may be easily adjusted.

In addition, since the maximum amount of liquid to be filled in a water tank is variable by adjusting the height of the switching unit 150, the position of the water level sensor 160 for detecting a high water level may be varied according to the maximum amount of liquid.

As set forth above, according to the exemplary embodiments of the present disclosure, since the water level senor is integrated in the float valve, the inside space of a product using the float valve maybe efficiently used, and parts of the product may be simply assembled.

In addition, according to the embodiments of the present disclosure, the amount of water in a water tank may be adjusted easily and conveniently.

While exemplary embodiments have been shown and described above, it will be apparent to those skilled in the art that modifications and variations could be made without departing from the spirit and scope of the present disclosure as defined by the appended claims.

What is claimed is:

1. A float valve comprising:
a frame;
a water supply part fixed to the frame and comprising a water supply nozzle through which water is discharged;
a vertical bar fixedly coupled to the frame and extending downwardly below the water supply unit;
a float connected to the vertical bar and vertically movable along the vertical bar;
a switching unit connected to the float and configured to open or close the water supply nozzle while being moved vertically according to vertical movement of the float; and
a water level sensor disposed on the vertical bar to detect a position of the float.

2. The float valve of claim 1, wherein the water level sensor comprises:
a reed switch fixed to the vertical bar; and
a magnet disposed on the float.

3. The float valve of claim 1, wherein the water level senor is provided on upper and lower sides of the vertical bar to detect high and low water levels.

4. The float valve of claim 1, wherein the switching unit comprises:
a connection lever having one end coupled to the float in a vertically rotatable manner;
a switching lever having one end coupled to the other end of the connection lever in a vertically rotatable manner and the other end coupled to the frame in a vertically rotatable manner, the switching lever being vertically rotatable under the water supply nozzle; and
a packing member disposed on the switching lever to open or close the water supply nozzle according to vertical movement of the switching lever.

5. The float valve of claim 1, wherein the water supply nozzle is formed through a lower side of the water supply part, and the float is vertically movable below the water supply nozzle,
wherein the switching unit comprises:
a packing support member disposed on an upper side of the float and adjustable in height; and
a packing member disposed on an upper end of the packing support member to open or close the water supply nozzle.

6. The float valve of claim 5, wherein the packing support member comprises:
a screw rod vertically disposed on the upper side of the float; and
a case screw coupled to the screw rod, the packing member being disposed on an upper end of the case.

7. The float valve of claim 5, wherein the vertical bar has a polygonal pipe or bar shape.

8. The float valve of claim 1, wherein an anti-shaking space is formed in a lower side of the float.
